(19) United States
(12) Patent Application Publication
(10) Pub. No.: US 2007/0085910 A1
(43) Pub. Date: Apr. 19, 2007

(54) Method and system for color correction of digital image data

(76) Inventors: Klaus Anderle, Darmstadt (DE); Pierre Ollivier, Culver, CA (US); Jurgen Stauder, Montreuil sur Ille (FR); Laurent Blonde, Thorigne-Fouillard (FR); Thierry Borel, Noyal sur Vilaine (FR); Khaled Sarayeddine, Nouvoitou (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/577,265

(22) PCT Filed: Oct. 29, 2004
(86) PCT No.: PCT/IB04/03866

§ 371 Date: Apr. 26, 2006

(30) Foreign Application Priority Data
Oct. 29, 2003 (EP) 03300181.9
Apr. 15, 2004 (EP) 04008969.0

(51) Int. Cl. H04N 9/73; G06T 7/00

(52) U.S. Cl. 348/223.1; 382/128

(57) ABSTRACT

What is proposed is a method for the color correction of digital image data generated by spectral absorption of white light in color filters of a first representation means. Color film material, in particular, is taken into consideration as the first representation means. For this purpose, firstly the primary color values R, G, B of the image data on the color film are detected. Said primary color values R, G, B are corrected in order to generate secondary color values R′, G′, B′ which are related to a second representation means, for example a monitor. This correction involves taking account of the absorption of light in secondary densities of the colorants of the film material which form the color filters of the first representation means. For this purpose, a plurality of absorption spectra are generated for different densities of the colorants. Finally, the spectral profile of the absorption spectra of the colorants influences the correction of the primary color values for generating the secondary color values. This follows the aim of achieving a maximum correspondence between the color representation with the first representation means and the color representation with the second representation means.

### SUMMARY OF THE INVENTION

The invention provides a system for managing color characteristics of images displayed by a display device on a display screen.

### BRIEF DESCRIPTION OF THE DRAWINGS

The drawing illustrates facts which serve to provide a better understanding of the invention. In the figures:

FIG. 1 diagrammatically shows the structure of a color film in cross section,

FIG. 2 shows the construction of a colorist's workstation in greatly simplified form,

FIG. 3 shows the spectral density of the blue, green and red color layers of a color film,

FIG. 4 shows a flowchart of the method according to the invention and

FIG. 5 shows color coordinates as a function of code values.

FIG. 6 shows a system according to an embodiment of the invention.

FIG. 7 shows a system according to an embodiment of the invention.

### DETAILED DESCRIPTION OF THE INVENTION

The invention provides a device and a method for color correction which, in comparison with the prior art, achieve an improved correspondence between the colors during reproduction with different representation means.

The method according to the invention serves for the color correction of digital image data generated by spectral absorption of white light in color filters of a first representation means. Firstly, the primary color values of the image data are detected, the primary color values being related to the first representation means. The primary color values are then corrected in order to generate secondary color values, which are related to a second representation means and which take account of the absorption of light in secondary densities of the color filters. According to the invention, a plurality of absorption spectra are generated for different densities of at least one color filter. Building on this, the spectral profile of the absorption spectra of the color filters influences the correction of the primary color values for generating the secondary color values.

One advantage of the method is that this achieves a better correspondence of the color reproduction between the first and second representation means.

In a development of the invention, intermediate spectra are calculated from the plurality of absorption spectra for different densities of the color filter. In this case, it may be expedient if a plurality of absorption spectra are generated for all the color filters.

In this case, intermediate spectra may be calculated for all the color filters. As a result, more data are available for the correction of the color values, which may, in principle, have a favorable effect on the correspondence of the color representations that is striven for.

Finally, provision may be made for convolving the spectra of the color filters with the spectral perception curve of a standard observer in order to generate the secondary color values. In this way, it is possible to take account of the physiological perception of colors by the human eye.

Efficient postprocessing relies upon, by way of example, the color representation on the monitors of a colorist corresponds as exactly as possible to the image projected in a cinema, for example. Nowadays, the starting point for postprocessing is generally digitized image data generated by film scanners or electronic cameras. Added to these are computer-generated images which are present as digital image data from the outset.

Devices which strive for such correspondence between color representations with different representation means are already commercially available as software and hardware solutions. These devices are based on the considerations described below.

Colors arise in different ways on different reproduction media. From the earliest times it has been known from painting that from just three different pigments, namely yellow, blue-green and purple-red, all intermediate hues can be produced by mixing the primary colors mentioned. Primary colors are understood to be those colors which cannot be mixed from other colors but from which all other colors can be mixed. In chromatics nowadays this type of color mixing is referred to as subtractive color mixing. The term subtractive color mixing is derived from the fact that a pigment layer absorbs certain spectral components of incident white light and reflects others, as a result of which the color impression arises for the viewer. Other types of color mixing were initially not known.

It was not until a long time later that Isaac Newton recognized that the spectral colors of the light, the so-called color stimuli, can also be mixed. With this type of color mixing the jargon uses the term additive mixing in contrast to subtractive color mixing explained above in the case of pigments. Additive color mixing is governed by relatively simple rules, known as Grassmann's laws, which also apply to self-luminous screens, such as, for example monitors based on cathode ray tubes.

A special case of subtractive color mixing is the combination or superposition of optical filters. The transmission of the filter combination is equal to the product of the respective transmissions of the individual filters, which is why the jargon also uses the term multiplicative color mixing in this case. This last-mentioned type of color mixing is also critical for color reproduction in the projection of color films which have three different color layers lying one above the other.

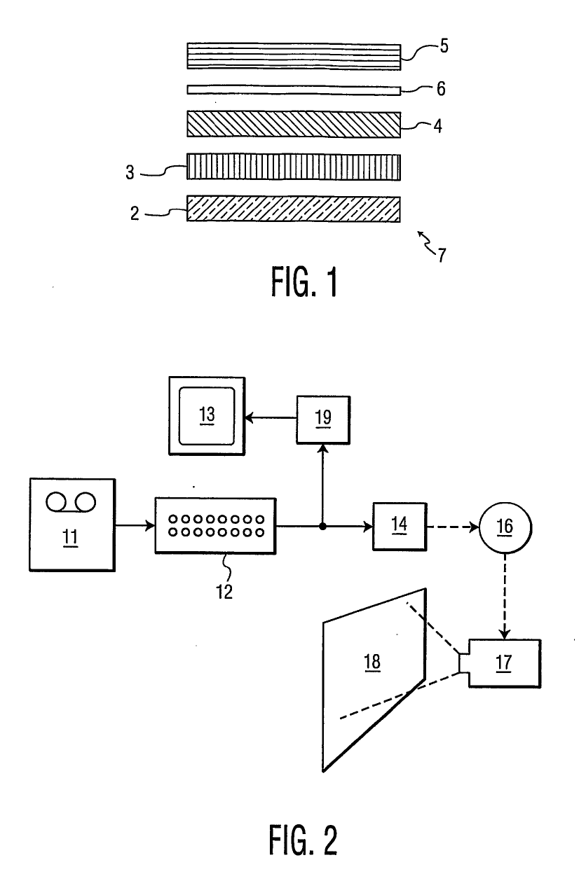

FIG. 1 diagrammatically shows an example of the construction of a color film 1 in cross section. A layer carrier 2 carries three color layers 3, 4, 5 having the primary colors red, green and blue, the red-sensitive color layer 3 adjoining the layer carrier 2 and the blue-sensitive color layer 5 forming the topmost color layer. A yellow filter 6 lies between the blue-sensitive and green-sensitive color layers 5 and 4, respectively. For the purpose of better illustration, the individual layers are represented spaced apart in FIG. 1 but in reality they adjoin one another. The intermediate layer for preventing interdiffusion of the green-sensitive and red-sensitive colorants is not taken into account here and is not illustrated in FIG. 1 since it has no influence on the color behavior of the film which is essential to the present invention.

One important difference between additive and multiplicative color mixing is that Grassmann's laws cannot be applied to multiplicative color mixing. The reason for this is to be found in the fact that, by way of example, as the thickness of a cyan filter increases, there is a decrease not only in the transmission in the red spectral range but also to a considerable extent in the green spectral range. This fact and the resulting consequences are explained in detail further below. In known color correction systems, therefore, the absorption of test patterns (“test patches”) is measured with the aid of densitometers and the absorption in the secondary densities is corrected by a transformation of the color coordinates.

It has been shown in practice, however, that despite these measures, the correspondence of colors is not always achieved during reproduction with different representation means.

FIG. 2 illustrates a colorist's workstation in greatly simplified form. In the course of film production, a first copy is made from the film material originally exposed by the camera. The copy is used to produce further prints which form the starting point for the postprocessing of the film. In FIG. 2, such a print is inserted in a film scanner 11. During the scanning of the print, the photographic image information is converted into digital image data and fed to a device 12 for color correction, which is usually operated by a colorist. During the correction of the film material, the colorist views the image to be processed on a monitor 13. The color representation on the monitor 13 is determined by color values at the output of the color correction device. The color values at the output of the color correction device 12 are also forwarded as control commands or “Code Values” to a film exposer 14, which exposes the data onto an internegative film. The content of the internegative film is then transferred to a positive film by means of a contact copy. The positive film is symbolized by a film reel 16 in FIG. 2. In order to inspect the result of the exposed film, the latter is projected onto a projection screen 18 by a film projector 17.

Ideally, the color representation of an image projected onto the projection screen 18 corresponds to the color representation of the same image on the monitor 13. For approximation to this ideal case, a device 19 for adjusting the color coordinates is connected between the color correction device 12 and the monitor 13. The adjustment device 19 converts the “Code Values” sent to the film exposer 14 into color coordinates for the monitor 13. The conversion has the aim of obtaining as far as possible identical color representations on the monitor 13 and the projection screen 18, respectively. The conversion method and the conversion device 19 are described in greater detail below.

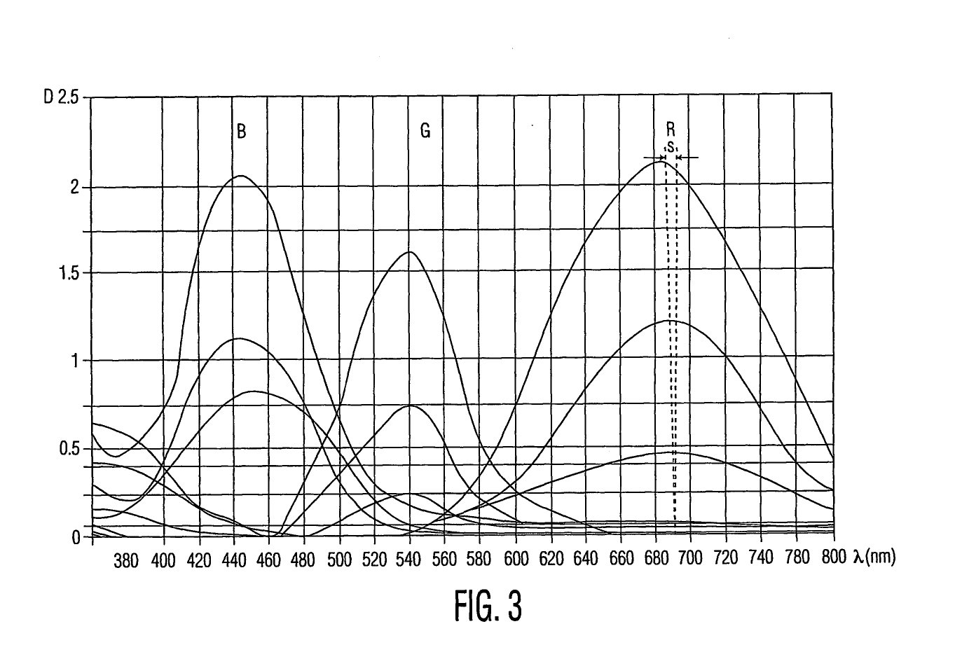

FIG. 3 illustrates spectral curves of in each case three color filters of different density for the colors red, green and blue. The density D is plotted on the ordinate and the wavelengths in nanometers (nm) are plotted on the abscissa. The density D of a filter is derived from the transmission T thereof in accordance with the following formula:
D=−log (T)

This means that at density zero, the relevant filter is completely transparent, and that the transmission decreases as the density increases. Density curves for filters with different transmissions are plotted for each of the primary colors red, green and blue. It can clearly be seen that, for the density curves for the red filter, by way of example, appreciable secondary maxima occur in the blue spectral range around 400 nm, and lead to a considerable absorption for the color impression. The same applies to a lesser extent to the density curves of the green filters. The density curves for the blue filters fall sharply in the wavelength range of between 440 nm and 380 nm in order to rise again below 380 nm. Furthermore, the density curves of the blue filters, with increasing density, exhibit a more and more highly pronounced plateau in the green spectral range around 550 nanometers, the plateau projecting right into the red spectral range. The absorption of a primary color filter in spectral ranges other than the spectral range assigned to the respective primary color is referred to as the “secondary density” of the density curve and results in color shifts during the projection of color films for example in the case of multiplicative color mixing. These effects are known in principle and are corrected for example by means of a linear transformation of the color coordinates. In order to better understand the extent to which the invention goes beyond the known methods, it is necessary firstly to discuss the conventional correction method in more detail.

Different film materials differ inter alia in the absorption properties of the colorants, which makes it necessary to adjust the color correction device 12 shown in FIG. 2 to a specific film material. For this purpose, the film exposer 14 exposes with predetermined code values so-called “test patches” i.e. image windows with different colors and color densities. This film material is then copied and produces the actual film. The test patches are then measured by densitometers in order to determine the absorption of a colorant in specific wavelength windows. The measurement characteristic of the densitometers is determined in accordance with DIN 4512-3 or a corresponding international standard. From this, the absorption of the colorants results not only in the principle maxima but also in the secondary maxima. The values determined in this way form the basis for the subsequent transformation of the color values which define the representation on the colorist's monitor 13. The transformed color values are corrected color values which define the illumination commands of the film exposer 14 and thus determine the subsequent color representation on the projection screen 18. To put it another way, the color values or code values which control the film exposer 14 are “predistorted” in order to compensate for the “distorting” influence of the colorants of the film material used.

It has been shown in practice, however, that the correspondence between the color representation on the monitor 13 and the projection screen 18 that is striven for in this way still leaves something to be desired. The purpose of the invention is to improve said correspondence.

In order to realize this aim, the invention commences at determination of the correction values. From the more precise consideration of the spectral density curves of the color filters as shown in FIG. 3, it is possible to derive further properties of the colorants which lead to color shifts. However, these properties cannot be identified by means of the densitometer measurements used in practice. This is because conventional densitometers permit only an integral consideration of the absorption properties of the colorants. Upon more precise consideration of the spectral absorption curves, a shift in the primary maxima toward shorter wavelengths can be discerned for all primary colors as the density increases. This shift S is represented using the example of the primary maximum for red in FIG. 3. Furthermore, the form of densities. It is exactly in this way that it is thus possible to determine and correspondingly describe the spectral influences of the particular film treatments during the copying process and the development.

In the case of conventional densitometer measurements, these changes are registered only as a change in the absorption in the respective measurement window. For this reason, it is not possible with densitometer measurements to determine the actual absorption at a specific wavelength. However, this is exactly what is important for as precise a correspondence as possible between the color representation on different representation means.

The invention therefore proposes measuring the test patches of the film materials using a spectrometer over the entire wavelength range and interpolating intermediate spectra from the spectra thus obtained. From the totality of the spectra, it is possible to, derive, for the three primary colors, tables which put a color value that determines the representation on the colorist's monitor 13 into a relationship with a code value of the film exposer 14. A three-dimensional table is produced overall in this way.

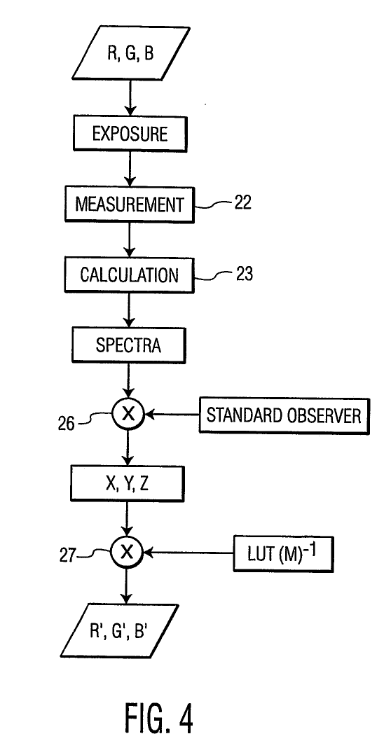

The method according to the invention is described in greater detail below with reference to FIG. 4. The starting point is formed by RGB color values which are output from the color correction device 12 to the monitor 13, on the one hand, and to the film exposer 14, on the other hand. In order to obtain a standardized color reproduction on the monitor 13, a so-called look-up table for the monitor LUT (M) is stored in the adjustment device 19, said table taking account of the reproduction properties of the monitor. In accordance with the flowchart in FIG. 4, the film is exposed in the film exposer in accordance with these RGB values. Said film is then copied onto the material to be projected. The color patterns or patches generated in this way are measured spectrally in a step 22. In addition to these measured spectra, further intermediate spectra are calculated in a step 23. The totality of the spectra generated in this way are convolved with the perception curves of a standard observer in a step 26 in order to generate color coordinates X, Y, Z corresponding to the RGB values. The color coordinates X, Y, Z are finally linked with an “inverted” look-up table of the monitor LUT(M)⁻¹ in a step 27. This produces new color values R′, G′, B′. The influence of the film material on the color reproduction can be derived from the differences between the color values R, G, B and R′, G′, B′. Further look-up tables are therefore generated from said differences and are stored in the adjustment device 19 and kept ready for application to the color values RGB. What is achieved in this way is that the color representation on the monitor 13 corresponds very well to the color representation on the projection screen 18.

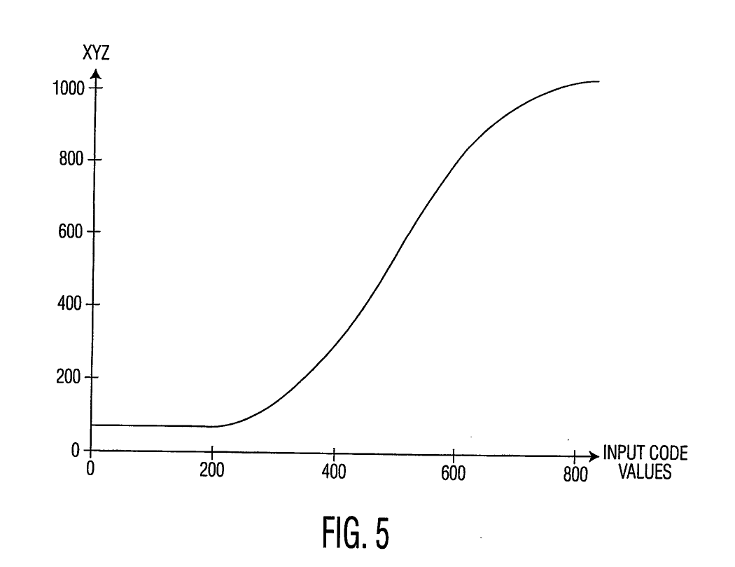

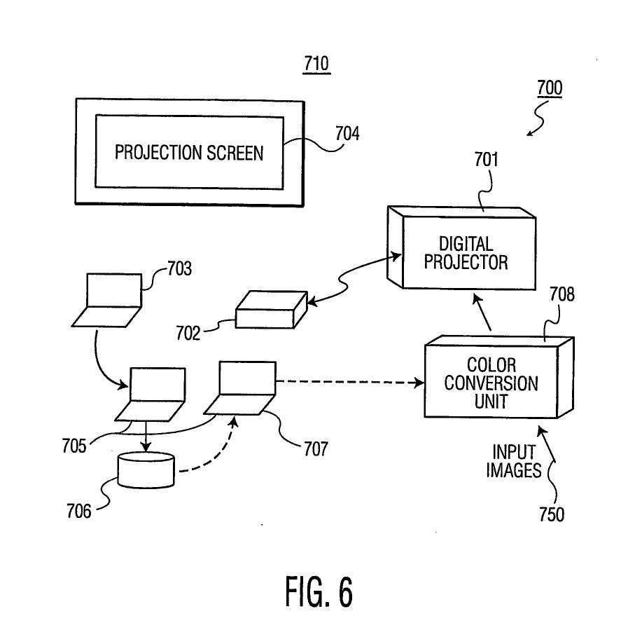

FIG. 5 shows the profile of one of the color coordinates X, Y, X as a function of the code values of the film exposer. The color coordinates are measured from the transmission of grey patches on the film material. The result permits a statement about the density distribution as a function of the code values, which is likewise taken into account in the calculation of the corrected color values R′, G′, B′.

FIG. 6 illustrates a system 700 according to an embodiment of the invention. System 700 provides a color management system. In one embodiment of the invention, the displayed image is displayed on a projection screen by projecting the image from a digital projector. Other embodiments of the invention display images on high definition monitors and display apparatus, cathode ray tube (CRT) type displays and any other display apparatus suitable for displaying video images.

A color conversion unit adjusts the colorimetric properties of the displayed images based on display device colorimetric characteristics and reference characteristics. Reference characteristics characterize images as they would appear in other circumstances, for example, on other display types. In that manner the calorimetric response of the display is adjustable to provide displayed images in accordance with a wide variety of selectable video image viewing experiences. In one embodiment of the invention, reference images comprise user selectable calorimetric response characteristics for the displayed image.

Therefore, selectable ones of a variety of “looks” for displayed images can be achieved, taking into account a plurality of characteristics that vary from circumstance to circumstance. For example, characteristic “looks” are affected by characteristics of display apparatus in use, ambient lighting conditions, image source device characteristics, desired film looks, projection screen types, and source image characteristics, to name but a few characteristics. In addition, the invention facilitates maintaining a consistent image look in a given display environment, regardless image processes and processing techniques, equipments and capture and storage media.

Video image source 750 (not shown) is coupled to digital projector 701 via color conversion unit 708. In one embodiment of the invention, reference image source 702 provides calibration images, referred to herein as “patches” to digital projector 701 for projection of the patches onto projection screen 704. In one embodiment of the invention, respective patches are projected onto screen 704 as part of a calibration process according to an embodiment of the invention.

Conventional calibration methods have drawbacks. On one hand they can be accurate, but time consuming, involving uniquely skilled human intervention. These conventional techniques depend heavily on film projection conditions. On the other hand, some conventional calibration methods are less accurate and very approximate. These methods introduce artificial distortions that are unacceptable to a professional film industry operator.

A calibration system and process of an embodiment of the invention comprises a set of color patches, for example, as created on 35 mm film. This set of color pateches provides a color reference sample. Using the technique of the invention, the color patches are capable of reproduction across various facilities using the same film process standard. This technique provides a valuable reference sample for display calibration. According to an example method of the invention, this technique includes detecting and correcting distortion. Distortion arises, for example, from film non-uniformity and projection light system non-uniformity.

According to an embodiment of the invention, a patch design is provided that allows for very short data capturing campaigns.

In one embodiment of the invention sampling patches are processed so as to provide measurement reference points, as well as interpolated points, for a three dimensional (3 D) look-up table (3 D-LUT). Based upon the LUT, images projected by projector 701 are adjusted to achieve a selected “look” for the images. In one embodiment of the invention, a 3 D-LUT is provided with 256×256×256 control points for any given color space.

Calibration processor 705 analyzes reference colorimetric characteristics and compares the reference characteristics to selected characteristics, for example, projector type, lens type, projector lamp output and the like. In one embodiment of the invention, reference characteristics are manually provided to calibration processor 705 by a human operator. In other embodiments of the invention, reference characteristics are stored in a memory (not shown) of calibration processor 705.

In one embodiment of the invention, reference characteristics comprise characteristics corresponding to devices to be emulated by screen 704. For example, one set of reference characteristics enables projector screen 704 to emulate an HD monitor. Another set of reference characteristics enables projector screen 704 to emulate a conventional CRT. Conversely, for a display device 704 comprising a conventional CRT, a set of reference characteristics enables display 704 to emulate a film projector. In one embodiment of the invention, reference characteristics corresponding to display devices are stored in a reference database. System 700 refers to selected reference device characteristics and to display device 704 color space response capability to generate a customized LUT for displaying images on display device 704 so, as to emulate a display device different that display device 704.

In still further embodiments of the invention, calibration processor 705 is provided with reference characteristics by a remote source of reference characteristics (not shown). Remote sources are selected from the group comprising centralized databases, remote computing systems, local area networks, and wide area networks such as the Internet, to name but a few. Remote sources are coupled to calibration processor 705 by suitable means. Examples of suitable means include the Internet, wireless transmission means, and cable, telephone, satellite and other transmission means.

Calibration processor 705 determines color offset information to be provided to color conversion unit 708 based upon the comparison. In one embodiment of the inventions, calibration processor 705 uses the color offset information to generate a LUT. The generated LUT is provided to color conversion unit 708. Thereafter, color conversion unit 708 operates on images supplied by image source 750 (not shown) in accordance with the generated LUT. The adjusted images are output from color conversion unit 708 and provided to projector 701. Projector 701, in turn, projects the adjusted images on projection screen 704.

Color Conversion Unit 708

Calibration processor 705 provides automated and substantially real-time color calibration adjustments of a display device, for example, a digital cinema projector. This feature provides the capability to emulate a film look consistently and reliably over time and distance. For example, an embodiment of the invention comprises a plurality sites using the same system. Therefore, systems and methods of the invention will find numerous applications in the post-production and digital intermediate world.

Other embodiments of the invention w comprises a color management unit coupled to a plurality of display devices 704. The color management unit manages a plurality of LUTS, display devices, data sources, projectors etc. In one embodiment of the invention, calibration processor 805 includes controls, operable by a user to manage a plurality of display environments, and to select display devices, emulation devices and color settings.

According to one embodiment of the invention, the adjusted images are then verified for proper colorimetry. According to one embodiment of the invention system 700 records a history of calibration settings and adjustments, for example in a database, thereby facilitating investigation of display events of interest to users, maintenance personnel, color technicians and system designers.

### EXAMPLE 2

### Post Production Image Processing

A photographic image captured on film contains a huge amount of information. Even today, there is no other medium capable of storing all this information without compromising aspect ratio, resolution, color space and contrast ratio. While a digital video image is distributed as a real time stream in a fixed format between equipment, data is handled as computer files which are subject to open, save, import and export functions. Many of these operations transform the original image data into different formats or color spaces.

The operator working via a simplified graphical user interface is rarely involved in the technical aspects of these operations. Therefore it is not transparent what alterations are being applied to the original image data. Often judging the final “filmed out” results can be very disappointing because the results bear little resemblance to what the artist derived on his graphic display device.

Usually the calibration process is either accurate and time consuming, involving uniquely skilled human intervention and very dependant on the film projection conditions, or it is very approximate and introduces many artificial distortions that are unacceptable to a professional film industry operator, because not enough measurement patches and points are taken into account.

Working with film in the digital domain relies on consideration of a wide variety of parameters to keep the original scanned information as transparent as possible through the entire post production chain. The aim is simple: to ensure that the look of the images as viewed on a grading display, is the same look recorded on the final output medium and displayed to a viewing audience. Final output medium ranges from film deliverables to the entire variety of today's SDTV, HDTV and DTV, video formats as well as DVD and Internet content. Another goal is to ensure the look viewed on the grading display and recorded on the final output medium is the same look displayed to a viewing audience, regardless of display device.

There follows a description with reference to FIG. 5 of a portion of a cinema laboratory processing system 20 according to one embodiment of the invention.

The processing system 20 depicted in FIG. 5 comprises an image scanner 21 such as is used to digitize, for example, a silver film. The digital data corresponding to the film is stored in memory, for example, in a memory of computer 22. One embodiment of processing system 20 further comprises a digital projector 23 by means of which the film is projected in a laboratory screening room for approval by the director. In that case, the projector 23 receives video. data recorded by the computer 22.

A video data processing device 103 is used to receive video data provided by computer 22 based upon the output of scanner 21. Video data processing device 103 transmits outgoing video data to digital projector 23. In some embodiments of the invention, processing device 103 is substantially similar to device 2 described hereinabove.

According to alternative embodiments of the invention, the digital data corresponding to the film is provided to a display device in, for example, a broadcast television monitoring suite. Class one video monitors are the typical choice for image display and monitoring of an output medium in such an environment. In one embodiment of the invention, the output is deliverable in a television format selected from the group comprising SDTV, HDTV and DTV standards. This format ensures that the images meet required broadcast standards. However, the color space afforded by such devices is somewhat limited compared to film. A conventional approach to achieving consistency in that case is to standardize CRT phosphors to ensure the video is reproduced consistently on a wide range of monitors manufactured to the corresponding standard.

Current standards for television monitoring include: SMPTE S170m for NTSC environments, ITU-R 601 for European environments (PAL/SECAM), and Sony BVM D24 E1WU ITU-R BT.709 for HDTV (720/1080 line standards) environments, and SMPTE S240m for HDTV (1125 line standards) environments.

In a broadcast video monitoring embodiment, video data processing device 103 is receives video data provided by computer 22, or other source of broadcast video data. Video data processing device 103 transmits outgoing video data to a studio monitor 23. In some embodiments of the invention, processing device 103 is substantially similar to device 2 described hereinabove.

The embodiments of the invention described above provide control and correction of color settings of digital display and projection devices, while matching the displayed colors with those of a reference color space, such as film. In particular, in digital post-production, digital intermediate processing, and broadcast studio environments, the invention provides control and correction of color settings of video monitoring display devices, while matching the displayed colors with those of other reference color spaces. Therefore embodiments of the invention provide control and correction of the color settings of a digital display or projection device, while accurately controlling the matching of the displayed colors with those from a film or any other reference color space for use in digital post-production and digital intermediate processing environments.

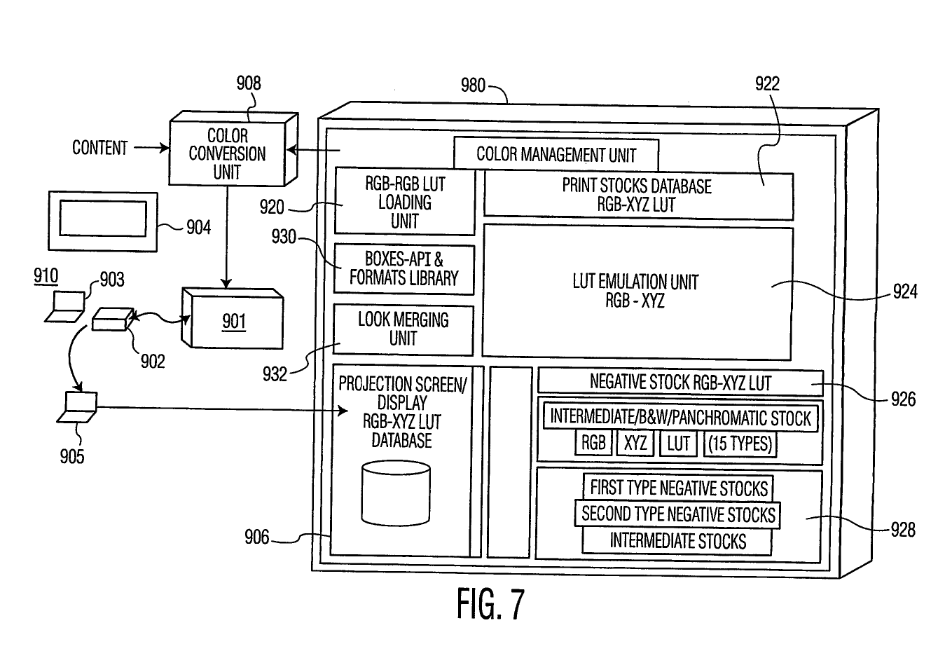

FIG. 7 illustrates a color management system 900 according to an embodiment of the invention. Color management system 900 comprises at least one video image source 950 (not shown), at least one source of reference images, e.g. reference color patches 902, at least one color conversion unit 908, at least one display device, for example projector 901 together with at least one projection screen 904, at least one calibration control unit 903, and at least one calibration processor 905. System 900 further comprises a color management unit 980.

Color management unit 980 comprises a display characterization unit 906, a film stock characterization unit 926, an emulation unit 924, a library unit 930, a look merging unit 932, and an RGB-RGB LUT loading unit 920. Display characterization unit 906, comprises a store, for example a database, comprising look up tables (LUTs). The LUTs comprise sets of color characteristics corresponding to display device color space conversion operations. That is, the LUTs provide information for converting a first color space, for example, an RGB color space, into a second color space, for example an XYZ color space, for a plurality of devices and color spaces.

Color Conversion Unit 908

A video image source 950 (not shown) is coupled to a display device 901, for example a digital projector, via a color-conversion unit 908. Also coupled to color conversion unit 908 is color management unit 980. Based on information provided by color management unit 980, color conversion unit 908 adjusts the video images from image source 950.

According to one embodiment of the invention, color conversion unit 908 comprises at least one Look Up Table (LUT) stored in a memory (not shown) of color conversion unit 908. In another embodiment of the invention color conversion unit 908 comprises an LUT provided by RGB-RGB LUT loading unit 920 of color management unit 980. In one embodiment of the invention, color conversion unit 908 implements a 3×3 matrix operation (M). The LUT performs a look up operation (L). In an embodiment of the invention, color conversion unit 908 is implemented by a processor. In one embodiment of the invention, .the look up operation is carried out by employing memory look up and addition operations only, without the need for further types of operations. This approach results in significant computation savings compared to algorithms requiring additional processing operations.

For a pixel of incoming 950, the pixel having values in R, G and B, color conversion unit 908 provides a corresponding pixel having values R′ G′ and B′. In one embodiment of the invention, R′G′B′ are given by:
R′=Mrr * Lr(R)+Mrg * Lg(G)+Mrb * Lb(B)
G′=Mgr * Lr(R)+Mgg * Lg(G)+Mgb * Lb(B)
B′=Mbr * Lr(R)+Mbg * Lg(G)+Mbb * Lb(B)

In one embodiment of the invention, the values of R, G, B and their corresponding LUT transformed values Lr(R), Lg(G), Lb(B) are between minimum and maximum digital values. Thus matrix elements can be looked up from pre-computed values stored in memory, since the elements are constants. In an embodiment of the invention, a linear matrix transform is implemented by a more general transform as follows:
R′=Mrr(Lr(R))+Mrg(Lg(G))+Mrb(Lb(B))
G′=Mgr(Lr(R))+Mgg(Lg(G))+Mgb(Lb(B))
B′=Mbr(Lr(R))+Mbg(Lg(G))+Mbb(Lb(B))

Therefore, each matrix element can be extended to a curve before multiplying by color values. Thus, the invention provides the capability for “bending” or otherwise modulating color spaces. In one embodiment of the invention, the conversion unit is implemented in an FPGA, i.e., a hardware configuration. In an embodiment of the invention, the color conversion unit 708 operates in real time and is capable of application to a plurality of standard input/output formats, including, for example. HDSDI, and analog VGA.

In an embodiment of the invention, color conversion unit 708 performs colorimetry transformation for a target display, for example, target image displayers 230 of FIG. 1. In that embodiment, color conversion unit 708 is coupled between image capture device 210 and target image displayer 230 so as to operate on the image representation as image data is transferred from image source to display device. Embodiments of the invention achieve accuracy appropriate for a specific application by employing first or second or higher order polynomial approximation of the general transform.

In one embodiment of the invention, color conversion unit 908 couples a 10 bit RGB source to a 10 bit display. Embodiments of the invention utilize 8 bit processing techniques. Some embodiments perform a 2 bit shift on the input signal (division by 4). Furthermore, some embodiments of the invention utilize a 2 bits padding operation performed on the output signal (multiplication by 4).

In one embodiment of conversion unit 908 of FIG. 9, scalars are replaced by Look-Up Tables (LUTs) in a matrix product operation. In such embodiments, for example, if (R,G,B) is an input triplet,: the output triplet (R′, G′, B′) is computed in accordance with:

$$( \begin{matrix}{R}^{′} \\ {G}^{′} \\ {B}^{′}\end{matrix} ) = ( \begin{matrix}{L}_{RR} ( R ) & {L}_{RG} ( G ) & {L}_{RB} ( B ) \\ {L}_{GR} ( R ) & {L}_{GG} ( G ) & {L}_{GB} ( B ) \\ {L}_{BR} ( R ) & {L}_{BG} ( G ) & {L}_{BB} ( B )\end{matrix} ) \cdot ( \begin{matrix}R \\ G \\ B\end{matrix} )$$

So as to implement the relationship:

$$\{ \begin{matrix}{R}^{′} = {L}_{RR} ( R ) \cdot R + {L}_{RG} ( G ) \cdot G + {L}_{RB} ( B ) \cdot B \\ {G}^{′} = {L}_{GR} ( R ) \cdot R + {L}_{GG} ( G ) \cdot G + {L}_{GB} ( B ) \cdot B \\ {B}^{′} = {L}_{BR} ( R ) \cdot R + {L}_{BG} ( G ) \cdot G + {L}_{BB} ( B ) \cdot B\end{matrix}$$

As each product depends only on one of R, G or B, it can be replaced by a more general LUT L′ writing: L′_{RR}(R)=L_{RR}(R).R, L′_{RG}(G)=L_{RG}(G).G, etc. . . .
to implement the following equations:

$$\{ \begin{matrix}{R}^{′} = {L}_{RR}^{′} ( R ) + {L}_{RG}^{′} ( G ) + {L}_{RB}^{′} ( B ) \\ {G}^{′} = {L}_{GR}^{′} ( R ) + {L}_{GG}^{′} ( G ) + {L}_{GB}^{′} ( B ) \\ {B}^{′} = {L}_{BR}^{′} ( R ) + {L}_{BG}^{′} ( G ) + {L}_{BB}^{′} ( B )\end{matrix}$$

According to an embodiment of the invention, for each output value (R′, G′ or B′) the processing steps implemented by conversion unit 908 comprise three look-up operations (one for R, one for G, one for B) followed by two additions. In one embodiment of the invention, each LUT table L′_{XY} is coded using 8 bits. Diagonal elements (L′_{RR}, L′_{GG}, L′_{BB}) comprise unsigned values between 0 and 255. Off-diagonal elements (L′_{RG}, L′_{RB}, L′_{GR}, L′_{GB}, L′_{BR}, L′_{BG}) comprise signed values between −128 and +127. In one embodiment of the invention, the output values R′, G′ and B′ are clipped between 0 and 255 (before 2 bits padding to be converted to 10 bits).

In an embodiment of the invention, conversion unit 908 is implemented as a Field Programmable Gate Array (FPGA) and connected to 1920×1080 10 bits in and out video interfaces.

In one embodiment of the invention, RGB-RGB loading unit 920 provides 9 Look-Up Tables L′_{RR}, L′_{RG}, L′_{RB}, L′_{GR}, L′_{GG}, L′_{GB}, L′_{BR}, L′_{BG}, L′_{BB} (in this order) of 256 values each to color conversion unit 908.

Embodiments of system 900 (illustrated in FIG. 9), include conversion unit 908 so as to provide color consistency from capture by capture devices 210 through conversion of the captured image into the digital domain as illustrated at 201 and 221 of FIG. 1. Embodiments of the invention further provide means for recovering initial color parameters at any step in the post-production chain, and provide seamless visual control at any step using for a plurality of selectable target displays. In that manner, a consistent color reference is utilized for file exchange across facilities at any step of the process.

The invention reduces the amount of expensive colorist's work for each new version. One embodiment of the invention automatically adapts to different visual environments, for example, a theatre version for complete dark environment, a broadcast version with scene contrast compression (to see the dark scenes in a dark living room). A DVD version is between broadcast and theatre versions (customer may want to turn the lights down in the living room).

According to one embodiment of the invention, color conversion unit 708 operates on incoming color image data (R,G,B) so as to provide outgoing color image data (R′G′B′) in accordance with the relationships:
R′=Mrr * Lr(R)+Mrg * Lg(G)+Mrb * Lb(B)
G′=Mgr * Lr(R)+Mgg * Lg(G)+Mgb * Lb(B)
B′=Mbr * Lr(R)+Mbg * Lg(G)+Mbb * Lb(B)

wherein R is a red value of said first color image, G is a green color value of said first color image, B is a blue color value of said first color image, M is a matrix operation and L is a look up table operation carried out upon red (R), green (G) and blue (B).

The adjusted images are provided to display device 901. In some embodiments of the invention, display device 901 displays the images directly on a display 904. In the embodiment of the invention illustrated in FIG. 9, display device 901 is a digital image projection device that projects the images onto a display screen 904.

Embodiments of system 900 further comprise a reference image source 902. Reference image source 902 provides calibration images, referred to herein as “patches” to digital projector 901 for projection of the patches onto projection screen 904. In one embodiment of the invention, respective patches are projected onto screen 904 as part of a calibration process. Calibration processor 905 provides calibration results for projector 901 to color management unit 980. Color management unit 980 stores the calibration results in a display calibration unit 906.

1. A method for the color correction of digital image data generated by spectral absorption of white light in color filters of a first representation means, the method comprising the following steps:
a) detection of the primary color values of the image data, the primary color values being related to the first representation means,
b) correction of the primary color values in order to generate secondary color values, which are related to a second representation means and which take account of he absorption of light in secondary densities of the color filters, wherein
c) a plurality of absorption spectra are generated for different densities of at least one color filter, and
d) the spectral profile of the absorption spectra of the color filters influences the correction of the primary color values for generating the secondary color values.

2. The method as claimed in claim 1, wherein intermediate spectra are calculated from the plurality of absorption spectra for different densities of the color filter.

3. The method as claimed in claim 1, wherein a plurality of absorption spectra are generated for all the color filters.

4. The method as claimed in claim 2, wherein intermediate spectra are calculated for all the color filters.

5. The method as claimed in claim 4, wherein the spectra of the color filters are convolved with the spectral perception curve of a standard observer in order to generate the secondary color values.

6. The method as claimed in claim 4, wherein the transmission of neutral filters of different density of the first representation means is measured in order to determine the density distribution of different colorants in the first representation means.

7. A video system comprising:
at least one input for receiving incoming video data, said incoming video data characterized by a first set of color characteristics;
at least one output for delivering outgoing video data to a display device, said outgoing data comprising a second set of color characteristics;
at least one database storing a plurality of sets of color characteristics;
at least one processor coupled to said database for converting said incoming video data into outgoing video data as a based upon at least on of said sets of characteristics stored in said database.
